(19) United States
(12) Patent Application Publication
(10) Pub. No.: US 2025/0253535 A1
(43) Pub. Date: Aug. 7, 2025

(54) COMPOUND DIELECTRIC RESONATOR ANTENNA

(71) Applicant: CORNING INCORPORATED, CORNING, NY (US)

(72) Inventors: Andrey Kobyakov, Painted Post, NY (US); Tianqi Ren, Painted Post, NY (US); Aleksandr Volkov, Espoo (FI)

(21) Appl. No.: 19/013,355

(22) Filed: Jan. 8, 2025

Related U.S. Application Data
(60) Provisional application No. 63/627,855, filed on Feb. 1, 2024.

(51) Int. Cl. H01Q 9/04; H01Q 1/48

(52) U.S. Cl. CPC H01Q 9/0485; H01Q 1/48

(57) ABSTRACT

A dielectric resonator antenna includes a ground plane defining at least one aperture, a dielectric substrate, and a resonator assembly. The resonator assembly includes a plurality of resonator structures, each resonator structure is coupled to the dielectric substrate. A probe extends through the at least one aperture in the ground plane and is coupled to the dielectric substrate.

### CROSS-REFERENCE TO RELATED APPLICATIONS

This application claims the benefit of priority to U.S. Provisional Patent Application No. 63/627,855 filed on Feb. 1, 2024, the content of which is incorporated herein by reference in its entirety for all purposes.

### BACKGROUND

The disclosure relates to a dielectric resonator antenna including a dielectric substrate and a resonator structure and methods of forming same.

Dielectric resonator antennas (“DRAs”) have found numerous applications due to their compact size, wide range of operation frequencies, relatively broad bandwidth, and high power-handling capacity. A typical DRA consists of a feeding structure connected to a ground plane and coupled to a resonator made of a low-loss high-permittivity dielectric material, such as glass or ceramic. The common feeder solutions are typically a vertical monopole or probe antenna protruding inside the resonator through a pre-drilled hole or a slot in the ground plane (magnetic dipole) which is excited by a microstrip transmission line on a separate substrate. The probe-fed DRA can be optimized as the main feeder parameters are just the probe length, diameter and the position inside the resonator. However, the fabrication process of the probe-fed DRAs can be tedious and expensive as it involves drilling a precise hole in the typically hard and brittle resonator materials such as glass or ceramics. Another conventional feeding structure (e.g., a slot in the ground plane) has challenges on its own. The slot-coupled design is more difficult to optimize due to a much larger number of parameters, which include the slot length, width, position, matching stub length, microstrip transmission line width and height, and substrate permittivity. In addition, precise alignment of the slot and the resonator is required.

Accordingly, there is a need for a dielectric resonator antenna that is easy to assemble and optimize.

### SUMMARY

According to one embodiment, a dielectric resonator antenna includes a ground plane defining at least one aperture, a dielectric substrate, and a resonator assembly. The resonator assembly includes a plurality of resonator structures, each resonator structure is coupled to the dielectric substrate. A probe extends through the at least one aperture in the ground plane and is coupled to the dielectric substrate.

According to another embodiment, a method of assembling a dielectric resonator antenna includes providing a ground plane defining at least one aperture, providing a dielectric substrate, and connecting the dielectric substrate to the ground plane. At least one resonator structure is provided and coupled to the dielectric substrate. A probe is provided and inserted through the at least one aperture in the ground plane and into contact with the dielectric substrate.

According to yet another embodiment, a method of assembling a dielectric resonator antenna includes providing a ground plane defining at least one aperture, providing a dielectric substrate and forming a plurality of holes in the dielectric substrate, and connecting the dielectric substrate to the ground plane. A plurality of resonator structures are provided and inserted into different ones of the plurality of holes. A probe is provided and inserted through the at least one aperture in the ground plane and one of the plurality of holes.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is an upper perspective view of a dielectric resonator antenna that includes a ground plane, a dielectric substrate, and a plurality of resonator structures, according to an aspect of the present disclosure;

FIG. 2A is top view of a dielectric substrate with a plurality of holes, according to an aspect of the present disclosure;

FIG. 2B is top view of a dielectric substrate with a plurality of resonator structures inserted into a plurality of holes in the dielectric substrate, according to an aspect of the present disclosure;

FIG. 3 is side view of a dielectric substrate with a plurality of resonator structures inserted into a plurality of holes in the dielectric substrate at different distances, according to an aspect of the present disclosure;

FIG. 4 is side view of a dielectric substrate with a plurality of resonator structures bonded to the dielectric substrate with an adhesive, according to an aspect of the present disclosure;

FIG. 5 is an upper perspective view of a dielectric resonator antenna that includes a ground plane, a dielectric substrate located in an aperture of the ground plane, and a plurality of resonator structures, according to an aspect of the present disclosure;

FIG. 6A illustrates a dielectric resonator antenna with a plurality of resonator structures in a triangular lattice, according to an aspect of the present disclosure;

FIGS. 6B-6D graphically depict the radiation pattern of the dielectric resonator antenna depicted in FIG. 6A with modifications to the design parameters, according to an aspect of the present disclosure;

FIG. 7A illustrates a dielectric resonator antenna with a plurality of resonator structures in a rectangular lattice, according to an aspect of the present disclosure;

FIGS. 7B-7D graphically depict the radiation pattern of the dielectric resonator antenna depicted in FIG. 7A with modifications to the design parameters, according to an aspect of the present disclosure;

FIG. 8A illustrates a dielectric resonator antenna with a plurality of resonator structures in a triangular lattice, according to an aspect of the present disclosure;

FIGS. 8B-8D graphically depict the radiation pattern of the dielectric resonator antenna depicted in FIG. 8A with modifications to the design parameters, according to an aspect of the present disclosure;

FIG. 9A illustrates a dielectric resonator antenna with a plurality of four resonator structures in a rectangular lattice, according to an aspect of the present disclosure;

FIGS. 9B-9C graphically depict the radiation pattern of the dielectric resonator antenna depicted in FIG. 9A, according to an aspect of the present disclosure;

FIG. 10A illustrates a dielectric resonator antenna with a plurality of sixteen resonator structures in a rectangular lattice, according to an aspect of the present disclosure;

FIGS. 10B-10C graphically depict the radiation pattern of the dielectric resonator antenna depicted in FIG. 10A, according to an aspect of the present disclosure;

FIG. 11A illustrates a dielectric resonator antenna with a plurality of thirty-six resonator structures in a rectangular lattice, according to an aspect of the present disclosure;

FIGS. 11B-11C graphically depict the radiation pattern of the dielectric resonator antenna depicted in FIG. 11A, according to an aspect of the present disclosure;

FIG. 12A illustrates a dielectric resonator antenna with a plurality of twenty-four resonator structures in a complex pattern, according to an aspect of the present disclosure;

FIGS. 12B-12C graphically depict the radiation pattern of the dielectric resonator antenna depicted in FIG. 12A, according to an aspect of the present disclosure;

FIG. 13A illustrates a dielectric resonator antenna with a plurality of twenty resonator structures in a complex pattern, according to an aspect of the present disclosure;

FIGS. 13B-13C graphically depict the radiation pattern of the dielectric resonator antenna depicted in FIG. 13A, according to an aspect of the present disclosure;

FIG. 14A illustrates a dielectric resonator antenna with a plurality of twenty-four resonator structures in a complex pattern, according to an aspect of the present disclosure;

FIGS. 14B-14D graphically depict the radiation pattern of the dielectric resonator antenna depicted in FIG. 14A, according to an aspect of the present disclosure;

FIG. 15A illustrates a dielectric resonator antenna with a plurality of resonator structures including conductive wires inserted therein, the plurality of resonator structures are in a triangular lattice, according to an aspect of the present disclosure;

FIGS. 15B-15C graphically depict the radiation pattern of the dielectric resonator antenna depicted in FIG. 15A, according to an aspect of the present disclosure;

FIGS. 16A and 16B illustrate a dielectric resonator antenna with a plurality of resonator structures in a triangular lattice and inserted into a dielectric substrate at different distances, according to an aspect of the present disclosure;

FIGS. 16C-16D graphically depict the radiation pattern of the dielectric resonator antenna depicted in FIGS. 16A and 16B, according to an aspect of the present disclosure; and

FIG. 17 is a flow chart illustrating a method of assembling a dielectric resonator antenna, according to an aspect of the present disclosure.

### DETAILED DESCRIPTION

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein-for example up, down, right, left, front, back, top, bottom-are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

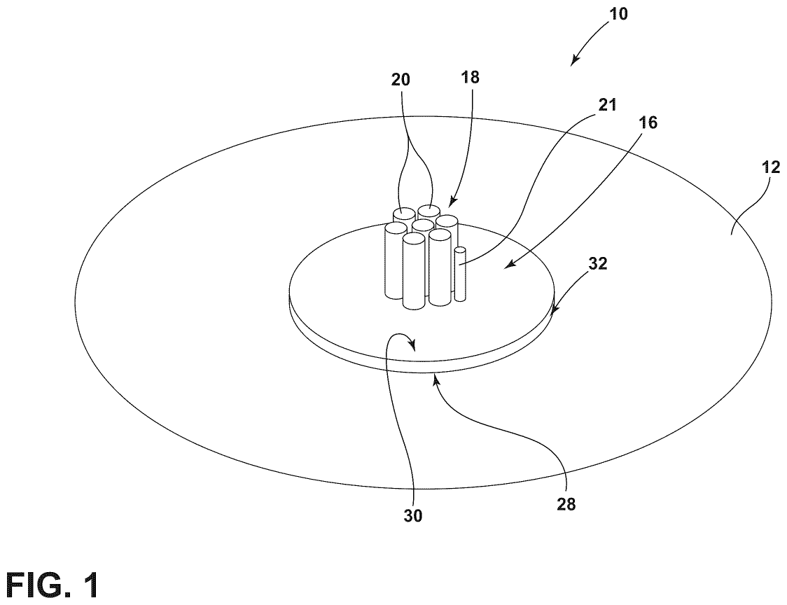

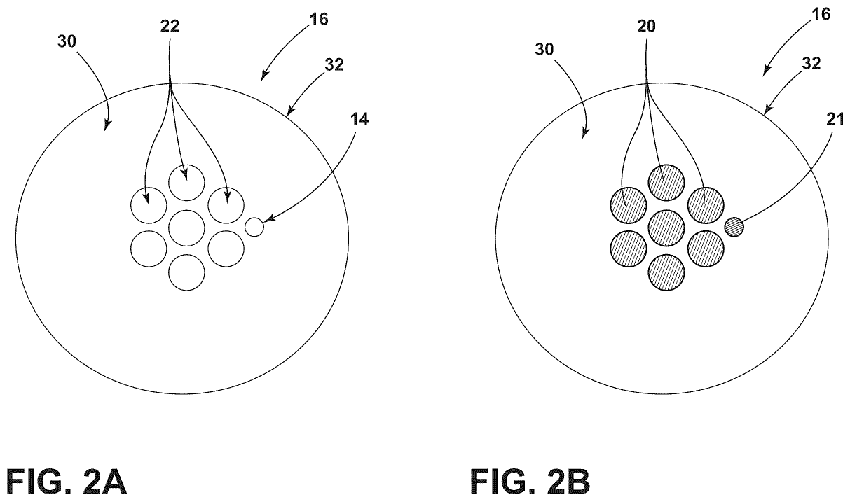

Referring now to FIGS. 1-2B, an exemplary, dielectric resonator antenna 10 is provided according to an embodiment of the disclosure. The dielectric resonator antenna 10 includes a ground plane 12 defining at least one aperture 14, a dielectric substrate 16, and a resonator assembly 18. The resonator assembly 18 includes at least one resonator structure 20 (e.g., a plurality of resonator structures 20), each resonator structure 20 is coupled to the dielectric substrate 16. A probe 21 extends through the at least one aperture 14 in the ground plane 12 and is coupled to the dielectric substrate 16.

With continued reference to FIGS. 1-2B, the dielectric resonator antenna 10 utilizes simple and readily available dielectric shapes, like glass or ceramic beads or cylinders, as building blocks (e.g., resonator structures 20). The resonator structures 20 can be placed around the probe 21, which may be preinstalled, thus eliminating the need for drilling glass or ceramics. Advantages of the dielectric resonator antenna 10 include the ease of fabrication and low fabrication cost, design flexibility and operation at various frequency bands (e.g., the number of resonator structures 20 affects the resonant frequency), and the ability to tune the dielectric resonator antenna 10 properties such as input impedance, operation frequency, bandwidth and the radiation pattern by choosing the appropriate position of the resonator structures 20. The dielectric resonator antenna 10 depicted includes six resonator structures 20 formed of zirconia. The probe 21 may be formed of a standard SMA connector, a widely available part.

With continued reference to FIGS. 1-2B, in some embodiments, the dielectric substrate 16 defines at least one hole 22 (e.g., a plurality of holes 22) and the at least one resonator structure 20 is located in the at least one hole 22. For example, the dielectric substrate 16 may define a plurality of the holes 22 and each resonator structure 20 may be located in at least two different holes 22. In still further embodiments, each resonator structure 20 is located in a different one of the holes 22. Each hole 22 is defined by a hole perimeter and each resonator structure 20 is defined by an outer resonator perimeter. In some embodiments, the resonator structure 20 forms an interference fit with the associated hole 22. For example, the outer resonator perimeter may be between about 98% and about 100% a size of the hole perimeter. In some embodiments, the holes 22 and aperture 14 may extend through both the dielectric substrate 16 and the ground plane 12. As explained above, the number, size, shape, location, and positioning of the resonator structures 20 can be assembled to optimize properties such as input impedance, operation frequency, bandwidth and the radiation pattern.

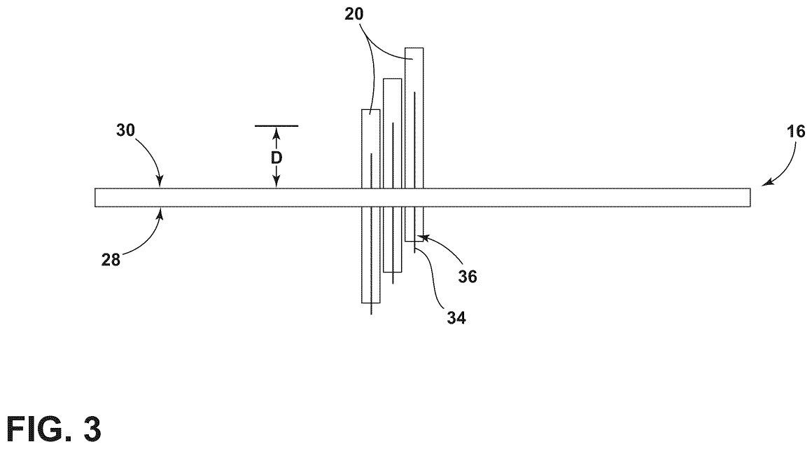

With reference now to FIG. 3, in addition to the number, size, shape, location, and positioning of the resonator structures 20, the properties of the dielectric resonator antenna 10 can be further optimized by a depth of the holes 22 and a distance “D” that the resonator structures 20 extend into a respective one of the holes 22. In some embodiments, at least two of the plurality of resonator structures 20 extend into a respective one of the holes 22 at different distances D. Further optimization can be obtained by selecting a shape of the resonator structures 20. For example, the resonator structures 20 may be at least one or more of a cylindrical shape, a rectangular prism shape, and a spherical shape. In some embodiments, each resonator structure 20 is formed of zirconia. For example, Zirconia cylinders (e.g., ferrules) traditionally utilized in fiber-optic connectors may be utilized as resonator structures 20.

While zirconia cylinders are described as one example of the resonator structures 20, it should be appreciated that any other shape can be used. In addition, it will be appreciated that the resonator structures 20 may be 3D printed or otherwise preformed. In some embodiments, the resonator structures 20 may be widely available ferrules used for fiber-optic connectors. In some embodiments, the ferrules (e.g., the zirconia cylinders) may have a diameter of 2.5 mm and length of 10.5 mm. However, there are also thinner ferrules (e.g., the zirconia cylinders) having a diameter of 1.25 mm. The usage of ferrules is beneficial because they are relatively inexpensive and widely available parts. The resonator structures 20 can be placed close to each other. For example, the resonator structures 20 can be packed in a rectangular or hexagonal lattice. The resonator structures 20 can be identical or different (e.g., in size, shape, material, distance D that the resonator structure 20 is inserted into the hole 22).

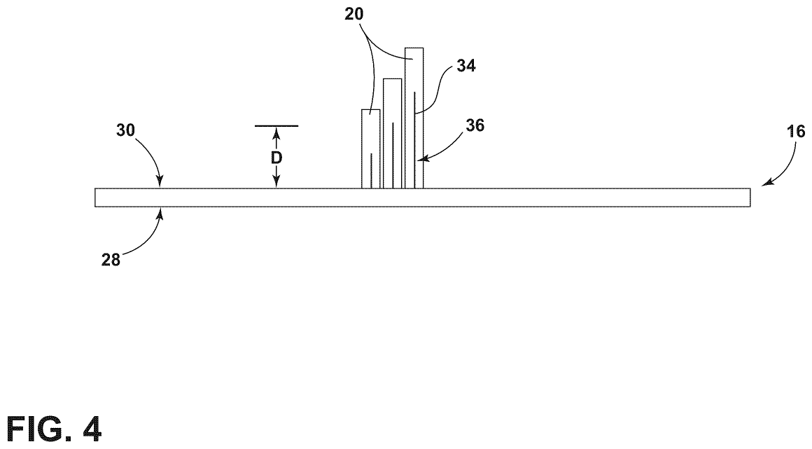

With continued reference to FIGS. 3 and 4, in some embodiments, the plurality of resonator structures 20 are glued to the ground plane 12. The term “glue” may refer to any bonding agent that facilitates attachment between components. For example, the glue may be located in the holes 22 and facilitate connection to the resonator structures 20. However, it should be appreciated that, in some embodiments, such as the dielectric resonator antenna 10 depicted in FIG. 4, the dielectric substrate 16 may not include any holes 22 and the resonator structures 20 may connected to the dielectric substrate 16 by glue only. More particularly, the dielectric substrate 16 defines a first surface 28 in contact with the ground plane 12 and a second surface 30 facing away from the ground plane 12. In embodiments without holes 22, the resonator structures 20 may be bonded directly to the first surface 28. Further, in embodiments with holes 22, each or select holes 22 may extend entirely through the first and second surfaces 28, 30 or be configured as blind holes that extend through the second surface 30 and terminate before the first surface 28. In some embodiments, the dielectric substrate 16 may be formed of glass or ceramic. In some embodiments, the dielectric substrate 16 may be a printed circuit board (“PCB”) with the first and/or second surface 28, 30 being metalized.

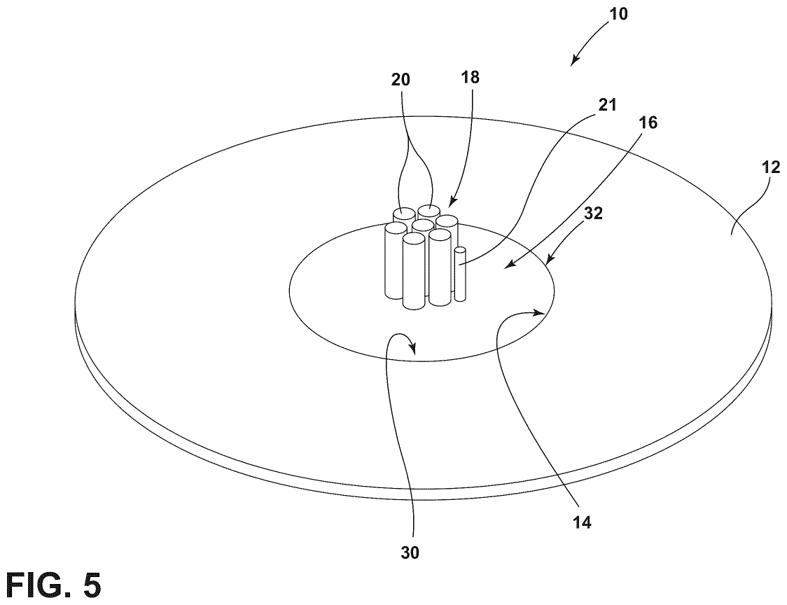

With reference now to FIGS. 3-5, in some embodiments, such as the dielectric resonator antenna 10 depicted in FIG. 5, the dielectric substrate 16 is located in the at least one aperture 14 within the ground plane 12 and defines an outer perimeter 32 in contact with the ground plane 12. In this manner, the dielectric substrate 16 contacts the ground plane 12 along the outer perimeter. In some embodiments, at least one of the plurality of resonator structures 20 extends through the at least one aperture 14 in the ground plane 12. With reference back to FIGS. 3 and 4, the properties of the dielectric resonator antenna 10 can be further optimized by inserting a conductive wire 34 (e.g., a metal wire) at least partially through one or more resonator structures 20. For example, the one or more resonator structures 20 may define a channel 36 and the conductive wire 34 may be inserted into the channel 36.

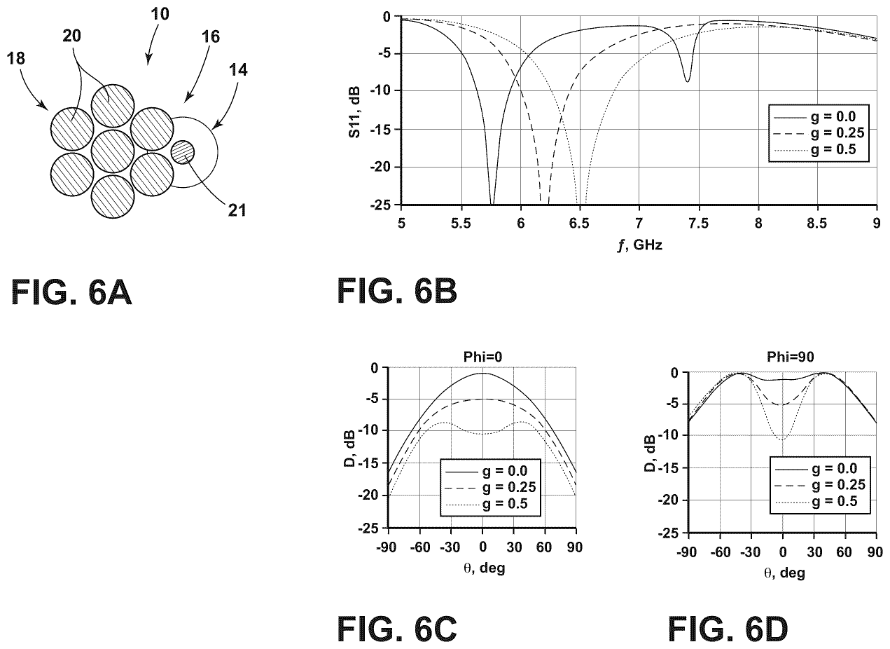

With reference to FIGS. 6A-16D, various specific examples of the dielectric resonator antenna 10 are illustrated. These specific examples are illustrative of how the number, size, shape, location, and positioning of the resonator structures 20, the distance the resonator structures 20 are inserted in holes 22, and the presence of conductive wire 34 are design parameters that affect the properties of the dielectric resonator antenna 10. These parameters provide design flexibility. For example, if multiple resonator structures 20 are used, several distinct locations of the probe 21 are possible. Unless otherwise specified, it should be appreciated that each of these specific examples may utilized the features previously described.

With reference now specifically to FIG. 6A, the dielectric resonator antenna 10 is depicted as including seven resonator structures 20 in a triangular lattice. FIGS. 6B-6D depict the radiation pattern of the dielectric resonator antenna 10 depicted in FIG. 6A with modifications to the design parameters. More particularly, each graphical representation in FIGS. 6B-6D includes a first line indicated by “g=0.0” where adjacent resonator structures 20 are touching, the probe 21 extends above the dielectric substrate 16 a distance of about 4.5 mm, operation at about 5.8 GHz (e.g., the resonant frequency), and with an antenna gain (“Dmax”) of about 5.8 dB. Each graphical representation in FIGS. 6B-6D further includes a second line indicated by “g=0.25” where adjacent resonator structures 20 are spaced from one another by amount 0.25 mm, the probe 21 extends above the dielectric substrate 16 a distance of about 6 mm, operation at about 6.2 GHZ, and with a Dmax of about 6.9 dB. In addition, each graphical representation in FIGS. 6B-6D further includes a third line indicated by “g=0.5” where adjacent resonator structures 20 are spaced from one another by amount 0.5 mm, the probe 21 extends above the dielectric substrate 16 a distance of about 7 mm, operating at about 5.6 GHz, and with a Dmax of about 7.5 dB. More particularly, FIG. 6B is a graphical representation of the reflection coefficient S11 and normalized antenna directivity of the dielectric resonator antenna 10 as a function of GHz (i.e., the resonant frequency). FIG. 6C is a graphical representation of the normalized antenna directivity of the dielectric resonator antenna 10 as a function of an elevation angle θ with an azimuth angle Φ equal to zero. FIG. 6D is a graphical representation of the normalized antenna directivity of the dielectric resonator antenna 10 as a function of the elevation angle θ with the azimuth angle Φ equal to π/2. It will be appreciated that the resonant frequency, gain and the radiation pattern are similar, with the increased distance between the resonant structures 20, both resonant frequency and antenna gain increase, and antenna bandwidth also slightly increases. However, the radiation pattern becomes more distorted, with maximum directivity at +/−40°.

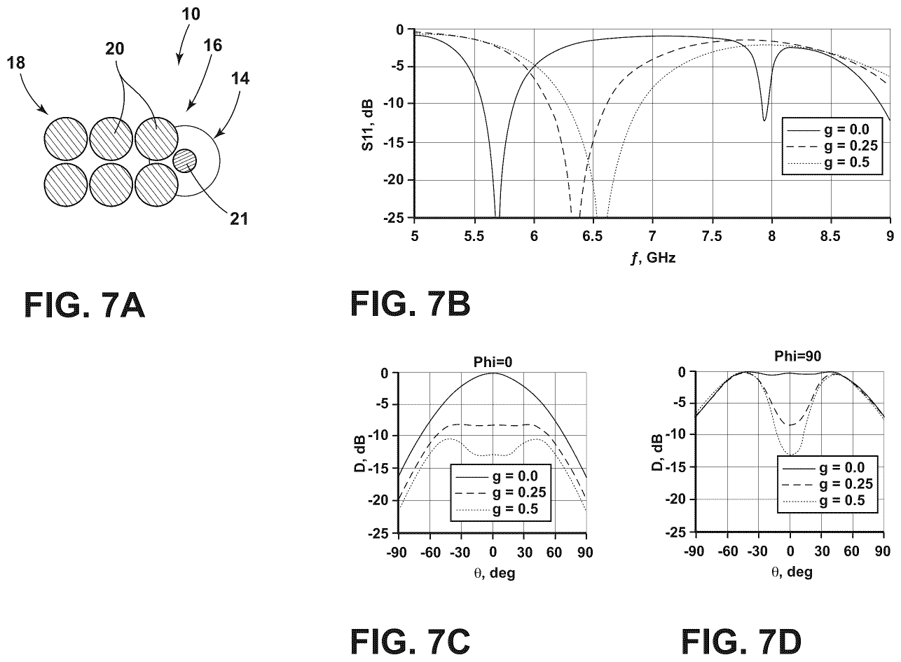

With reference now s to FIG. 7A, the dielectric resonator antenna 10 is depicted as including six resonator structures 20 in a rectangular lattice. FIGS. 7B-7D depict the radiation pattern of the dielectric resonator antenna 10 depicted in FIG. 7A with modifications to the design parameters. More particularly, each graphical representation in FIGS. 7B-7D include a first line indicated by “g=0.0” where adjacent resonator structures 20 are touching, the probe 21 extends above the dielectric substrate 16 a distance of about 6.5 mm, operation at about 6.4 GHz, and with a Dmax of about 5.9 dB. Each graphical representation in FIGS. 7B-7D further includes a second line indicated by “g=0.25” where adjacent resonator structures 20 are spaced from one another by amount 0.25 mm, the probe 21 extends above the dielectric substrate 16 a distance of about 6.5 mm, operation at about 6.4 GHz, and with a Dmax of about 6.9 dB. In addition, each graphical representation in FIGS. 7B-7D further includes a third line indicated by “g=0.5” where adjacent resonator structures 20 are spaced from one another by amount 0.5 mm, the probe 21 extends above the dielectric substrate 16 a distance of about 7.5 mm, operating at about 6.6 GHz, and with a Dmax of about 7.7 dB. More particularly, FIG. 7B is a graphical representation of the reflection coefficient S11 and normalized antenna directivity of the dielectric resonator antenna 10 as a function of GHz (i.e., the resonant frequency). FIG. 7C is a graphical representation of the normalized antenna directivity of the dielectric resonator antenna 10 as a function of an elevation angle θ0 with an azimuth angle Φ equal to zero. FIG. 7D is a graphical representation of the normalized antenna directivity of the dielectric resonator antenna 10 as a function of the elevation angle θ with the azimuth angle Φ equal to π/2. It will be appreciated that the resonant frequency, gain and the radiation pattern are similar, with the increased distance between the resonant structures 20, both resonant frequency and antenna gain increase, and antenna bandwidth also slightly increases. However, the radiation pattern becomes more distorted, with maximum directivity at +/−40°.

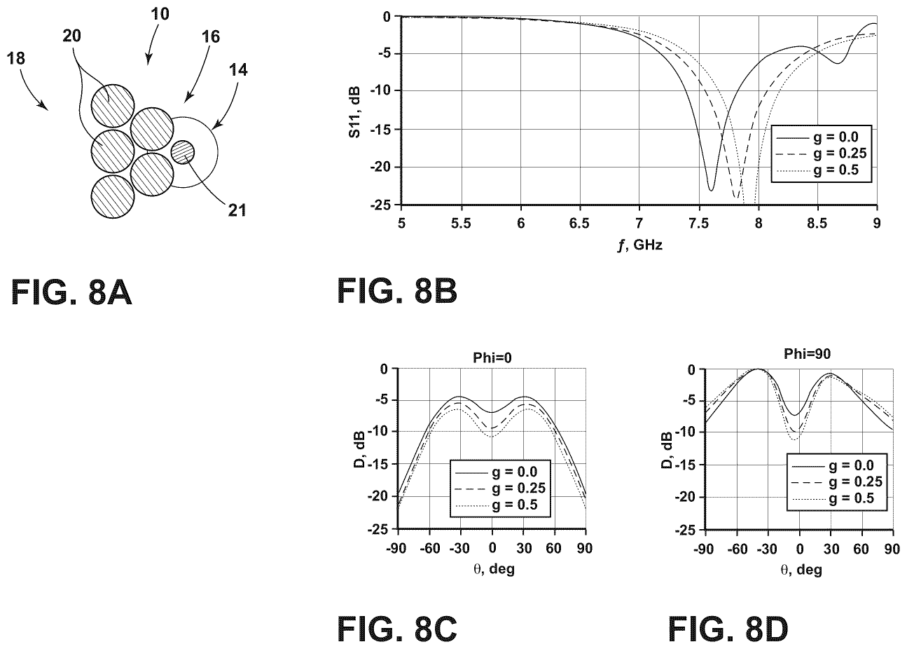

With reference now s to FIG. 8A, the dielectric resonator antenna 10 is depicted as including five resonator structures 20 in a triangular lattice. FIGS. 8B-8D depict the radiation pattern of the dielectric resonator antenna 10 depicted in FIG. 8A with modifications to the design parameters. More particularly, each graphical representation in FIGS. 8B-8D include a first line indicated by “g=0.0” where adjacent resonator structures 20 are touching, the probe 21 extends above the dielectric substrate 16 a distance of about 3.5 mm, operation at about 7.6 GHz, and with a Dmax of about 7.9 dB. Each graphical representation in FIGS. 8B-8D further includes a second line indicated by “g=0.25” where adjacent resonator structures 20 are spaced from one another by amount 0.25 mm, the probe 21 extends above the dielectric substrate 16 a distance of about 5 mm, operation at about 7.8 GHz, and with a Dmax of about 7.9 dB. In addition, each graphical representation in FIGS. 8B-8D further includes a third line indicated by “g=0.5” where adjacent resonator structures 20 are spaced from one another by amount 0.5 mm, the probe 21 extends above the dielectric substrate 16 a distance of about 5.5 mm, operating at about 8.0 GHz, and with a Dmax of about 7.8 dB. More particularly, FIG. 8B is a graphical representation of the reflection coefficient S11 and normalized antenna directivity of the dielectric resonator antenna 10 as a function of GHz (i.e., the resonant frequency). FIG. 8C is a graphical representation of the normalized antenna directivity of the dielectric resonator antenna 10 as a function of an elevation angle Φ with an azimuth angle Φ equal to zero. FIG. 8D is a graphical representation of the normalized antenna directivity of the dielectric resonator antenna 10 as a function of the elevation angle θ with the azimuth angle Φ equal to π/2. It will be appreciated that the resonant frequency, gain and the radiation pattern are similar, with the increased distance between the resonant structures 20, both resonant frequency and antenna gain increase, and antenna bandwidth also slightly increases. However, the radiation pattern becomes more distorted, with maximum directivity at +/−40°.

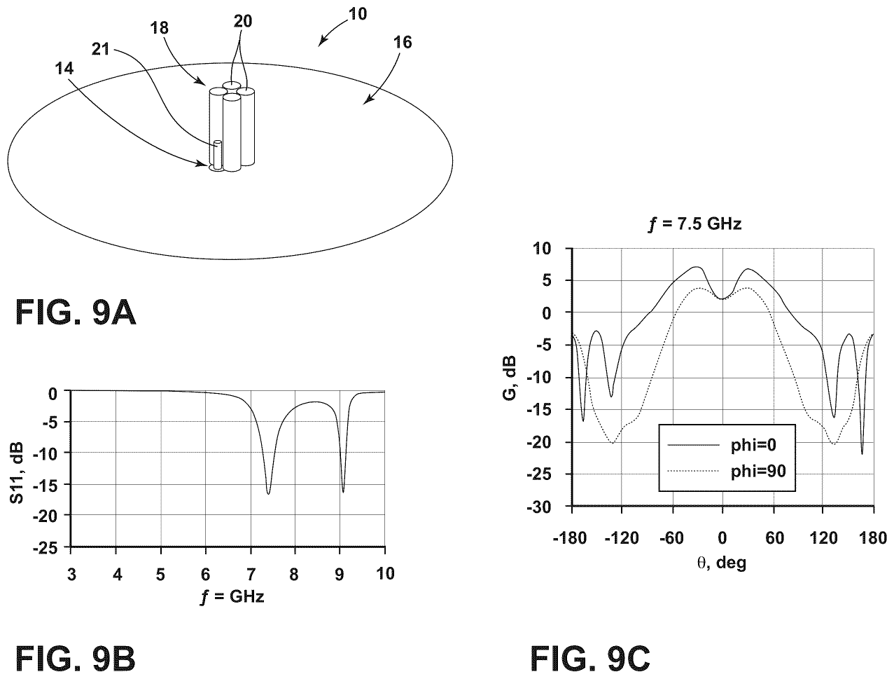

With reference now to FIGS. 9A-11C, various additional specific examples of the dielectric resonator antenna 10 are illustrated. These specific examples are illustrative of how smaller-diameter zirconia cylinders in a rectangular grid with individual cylinders touching each other (g=0) affect the properties of the dielectric resonator antenna 10. In FIGS. 9A-11C, the probe 21 is configured as a coaxial cable with inner conductor diameter of 0.94 mm. The probe 21 height (e.g., extending from the ground plane 12) is varied between the embodiments depicted in FIGS. 9A-11C. The resonator structures 20 are illustrated as zirconia cylinders with a 1.25 mm diameter. As expected, the resonant frequency decreases with increased size of and/or the number of resonator structures 20), while antenna gain remains the same at about 7 dB.

With specific reference now to FIGS. 9A-9C, the dielectric resonator antenna 10 is depicted as including four resonator structures 20 in a rectangular lattice. FIGS. 9B-9C depict the radiation pattern of the dielectric resonator antenna 10 depicted in FIG. 9A. FIG. 9A is a graphical representation of the reflection coefficient S11 and normalized antenna directivity of the dielectric resonator antenna 10 as a function of GHz (i.e., the resonant frequency). FIG. 9B includes a first line indicated by “phi=0” with an azimuth angle Φ equal to zero and a second line indicated by “phi=90” with the azimuth angle Φ equal to π/2.

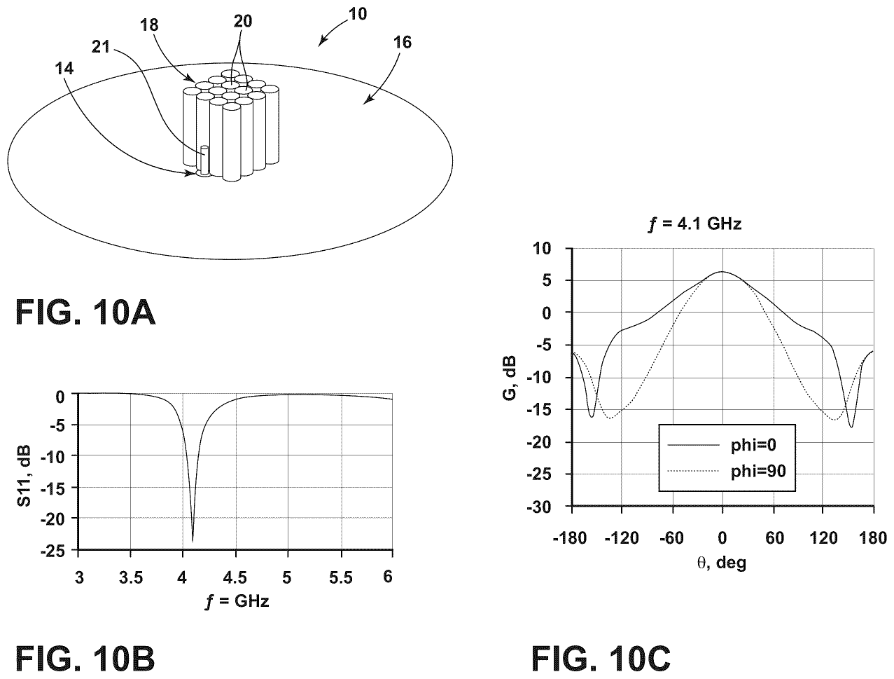

With specific reference now to FIGS. 10A-10C, the dielectric resonator antenna 10 is depicted as including sixteen resonator structures 20 in a rectangular lattice with the probe 21 located on an outer perimeter of the rectangular lattice. FIGS. 10B-10C depict the radiation pattern of the dielectric resonator antenna 10 depicted in FIG. 9A. FIG. 9A is a graphical representation of the reflection coefficient S11 and normalized antenna directivity of the dielectric resonator antenna 10 as a function of GHz (i.e., the resonant frequency). FIG. 9B includes a first line indicated by “phi=0” with an azimuth angle Φ equal to zero and a second line indicated by “phi=90” with the azimuth angle Φ equal to n/2.

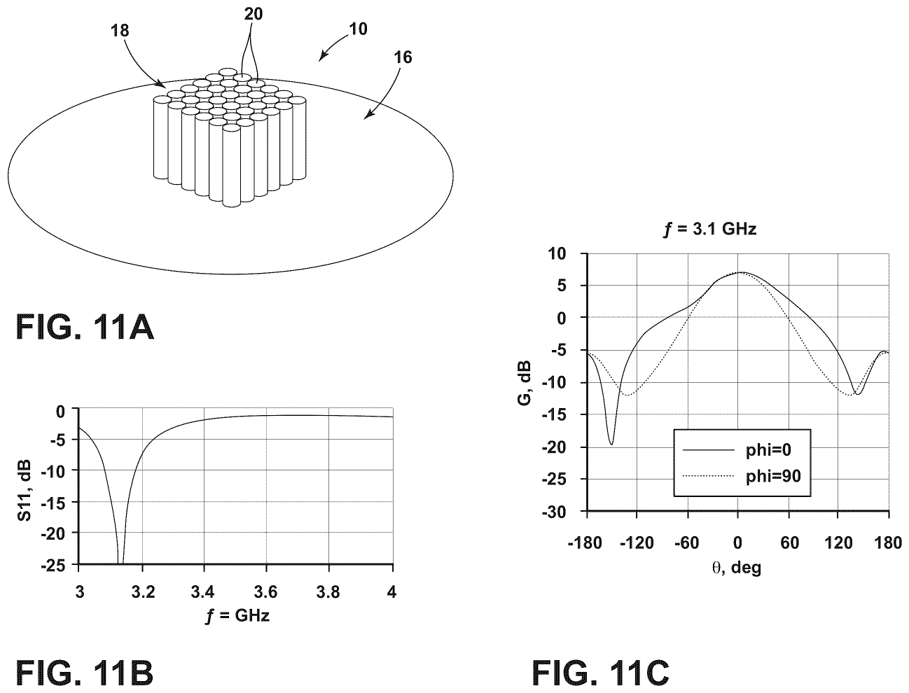

With reference now to FIGS. 11A-11C, the dielectric resonator antenna 10 is depicted as including thirty-six resonator structures 20 in a rectangular lattice with the probe 21 located within the rectangular lattice. FIGS. 11B-11C depict the radiation pattern of the dielectric resonator antenna 10 depicted in FIG. 9A. FIG. 11A is a graphical representation of the reflection coefficient S11 and normalized antenna directivity of the dielectric resonator antenna 10 as a function of GHz (i.e., the resonant frequency). FIG. 11B includes a first line indicated by “phi=0” with an azimuth angle Φ equal to zero and a second line indicated by “phi=90” with the azimuth angle Φ equal to π/2.

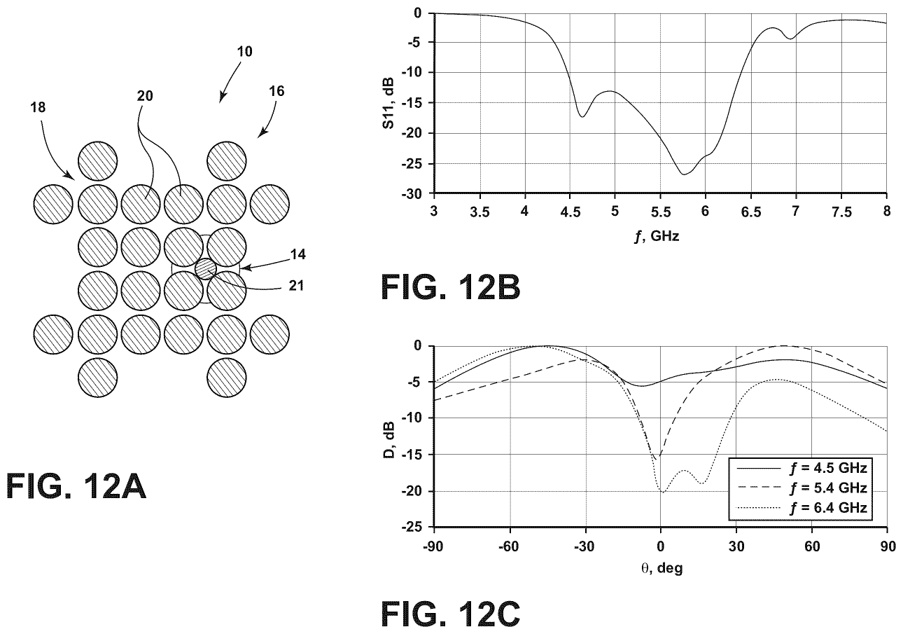

With reference now to FIGS. 12A-14D, various additional specific examples of the dielectric resonator antenna 10 are illustrated with complex resonator structure 20 patterns. As discussed above, the advantage of the various embodiments is not only in eliminating the requirement to mechanically process (e.g., drill) the resonator, but also in the ability to create various, sometimes non-intuitive resonator structure 20 patterns to target the specific properties of the dielectric resonator antenna 10 such as resonant frequency or bandwidth. It can be seen from the simulations below that a complex resonator structure 20 pattern allows for a significantly larger dielectric resonator antenna 10 bandwidth.

With reference now to FIGS. 12A-12C, the dielectric resonator antenna 10 is depicted as including twenty-four resonator structures 20 in a symmetrical pattern with the probe 21 located within the pattern. The resonator structures 20 are illustrated as zirconia cylinders with a diameter of 2.5 mm. FIG. 12B is a graphical representation of the reflection coefficient S11 and normalized antenna directivity of the dielectric resonator antenna 10 as a function of GHz (i.e., the resonant frequency). FIG. 12C illustrates a normalized antenna directivity as a function of an elevation angle θ with an azimuth angle Φ n/2. FIG. 12C includes three lines with Dmax or antenna gain listed as “f=4.5 GHZ,” “f=5.4 GHZ,” and “f=6.4 GHz.” The adjacent resonator structures 20 are spaced by 0.25 mm, and the probe 21 extends above the dielectric substrate 16 a distance of about 8 mm.

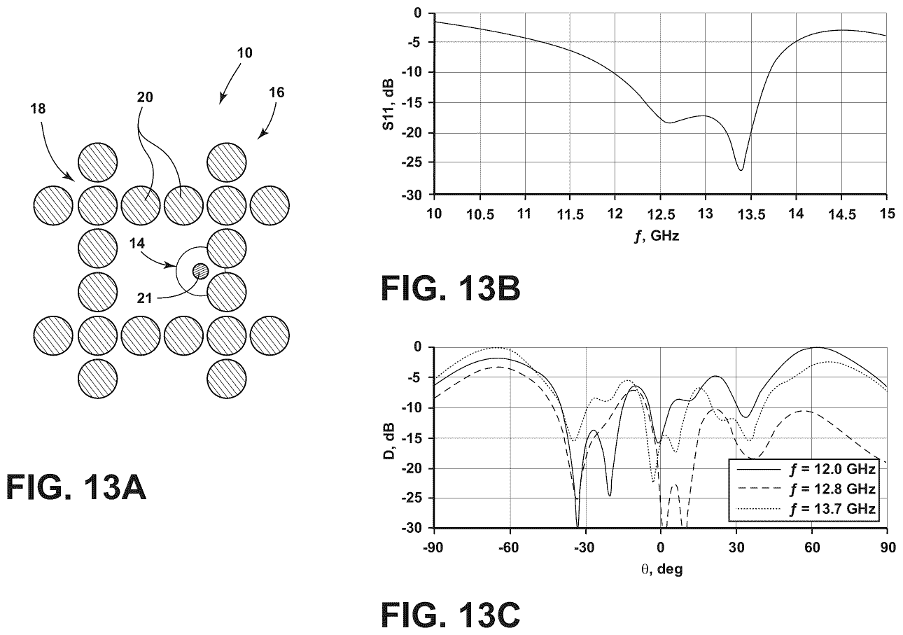

With reference now to FIGS. 13A-13C, the dielectric resonator antenna 10 is depicted as including twenty resonator structures 20 in a symmetrical pattern with the probe 21 located within the pattern. The resonator structures 20 are illustrated as zirconia cylinders with a diameter of 1.25 mm. FIG. 13B is a graphical representation of the reflection coefficient S11 and normalized antenna directivity of the dielectric resonator antenna 10 as a function of GHz (i.e., the resonant frequency). FIG. 13C illustrates a normalized antenna directivity as a function of an elevation angle θ with an azimuth angle Φ π/2. FIG. 12C includes three lines with Dmax or antenna gain listed as “f=12.0 GHZ,” “f=12.8 GHZ,” and “f=13.7 GHZ.” The adjacent resonator structures 20 are spaced by 0.25 mm, and the probe 21 extends above the dielectric substrate 16 a distance of about 4.65 mm.

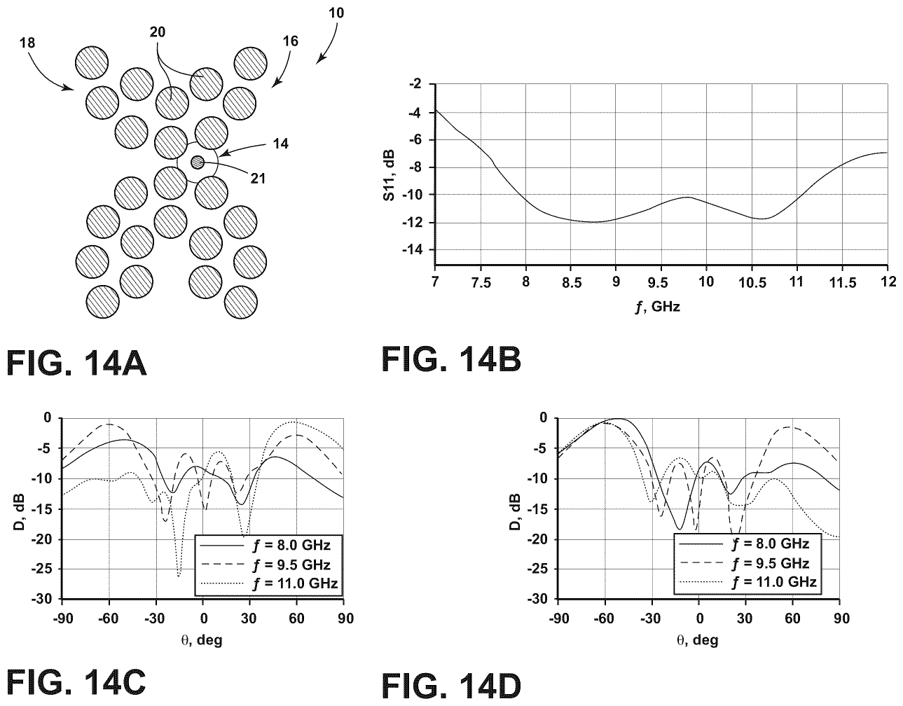

With reference now to FIGS. 14A-14C, the dielectric resonator antenna 10 is depicted as including twenty-four resonator structures 20 in a pattern with the probe 21 located within the pattern (e.g., within a central region of the pattern). The resonator structures 20 are illustrated as zirconia cylinders with a diameter of 1.25 mm. FIG. 14B is a graphical representation of the reflection coefficient S11 and normalized antenna directivity of the dielectric resonator antenna 10 as a function of GHz (i.e., the resonant frequency). FIG. 14C illustrates a normalized antenna directivity as a function of an elevation angle θ with an azimuth angle Φ π/2. FIG. 14C includes three lines with Dmax or antenna gain marked as “f=8.0 GHZ,” “f=9.5 GHZ,” and “f=11.0 GHz.” FIG. 14C includes an azimuth angle Φ equal to zero or phi=0. The adjacent resonator structures 20 are spaced by 0.33 mm, and the probe 21 extends above the dielectric substrate 16 a distance of about 6.9 mm. FIG. 14D illustrates a normalized antenna directivity as a function of an elevation angle θ with an azimuth angle Φ π/2. FIG. 14D includes three lines with Dmax or antenna gain marked as “f=8.0 GHZ,” “f=9.5 GHZ,” and “f=11.0 GHz.” FIG. 14D includes an azimuth angle Φ equal to π/2 or phi=90. The adjacent resonator structures 20 are spaced by 0.33 mm, and the probe 21 extends above the dielectric substrate 16 a distance of about 6.9 mm.

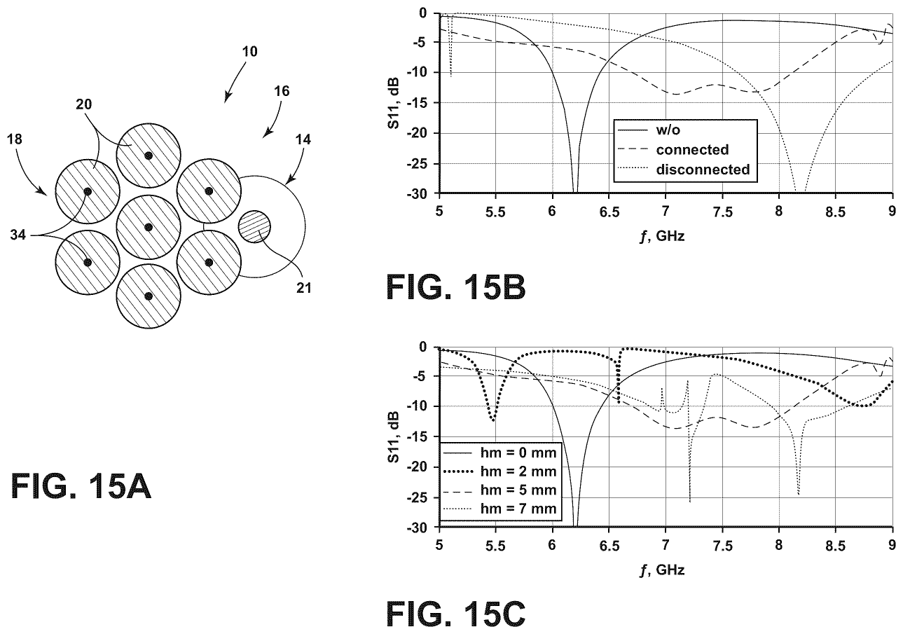

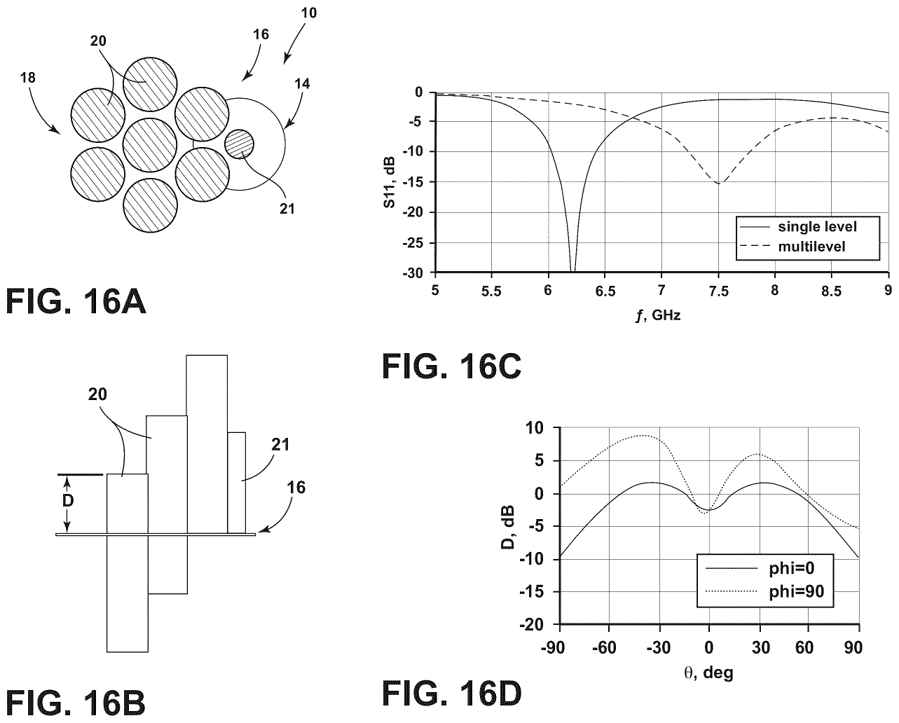

With reference now to FIGS. 15A-16D, various additional specific examples of the dielectric resonator antenna 10 are illustrated with resonator structures 20 formed of zirconia ferrules. Zirconia ferrules can introduce another tuning capability. At least some of (e.g., each of) the resonator structures 20 include the channel 36, which is shaped as a micro-hole with a diameter 126 um passing along a resonator structure axis and can be used to insert the conductive wire 34.

With reference now to FIGS. 15A-15C, the dielectric resonator antenna 10 is depicted as including seven resonator structures 20 in a triangular lattice with the probe 21 located outside the triangular lattice. The resonator structures 20 are illustrated as zirconia ferrules with a diameter of 1.25 mm and a conductive wire 34 located in each of the resonator structures 20. The conductive wires 34 may be connected or disconnected to the ground plane 12. FIG. 15B is a graphical representation of the reflection coefficient S11 and normalized antenna directivity of the dielectric resonator antenna 10 as a function of GHz (i.e., the resonant frequency). FIG. 15B includes three lines, the first line is marked as “w/o” indicating resonator structures 20 without conductive wires 34, the second line is marked “connected” indicating resonator structures 20 with conductive wires 34 connected to the ground plane 12, and the third line is marked “disconnected” indicating resonator structures 20 with conductive wires that are not connected to the ground plane 12. FIG. 15C is also a graphical representation of the reflection coefficient S11 and normalized antenna directivity of the dielectric resonator antenna 10 as a function of GHz (i.e., the resonant frequency). However, FIG. 15C includes four lines marked “hm=0 mm,” “hm=2 mm,” “hm=5 mm,” and “hm=7 mm,” where hm is the height of the resonator structures 20 extending from the dielectric substrate 16. In FIGS. 15A-15C, the resonator structures 20 are spaced by 0.25 mm and the probe 21 extends above the dielectric substrate 16 a distance of about 6 mm.

With reference now to FIGS. 16A-16D, the dielectric resonator antenna 10 is depicted (FIG. 16A) as including seven resonator structures 20 in a triangular lattice with the probe 21 located outside the triangular lattice. In FIG. 16B, the resonator structures 20 are illustrated as zirconia ferrules extending through respective holes 22 at different distances D. The insertion distance D of resonator structures 20 deeper through the dielectric substrate 16 can be used to shift resonant frequency of the dielectric resonator antenna 10. FIG. 16C is a graphical representation of the reflection coefficient S11 and normalized antenna directivity of the dielectric resonator antenna 10 as a function of GHz (i.e., the resonant frequency). FIG. 16C includes two lines, the first line is marked as “single level” indicating resonator structures 20 are either located in holes 22 the same distance D or otherwise extend the same distance from the dielectric substrate 16, the second line is marked “multilevel” indicating resonator structures 20 are either located in holes 22 at different distances D or otherwise extend different distances from the dielectric substrate 16. FIG. 16D depicts the radiation pattern of the dielectric resonator antenna 10 that includes a first line indicated by “phi=0” with an azimuth angle Φ equal to zero and a second line indicated by “phi=90” with the azimuth angle Φ equal to π/2. In FIGS. 16A-16D, the resonator structures 20 are located 0.25 mm apart and have a length of 6.0 mm. In the multi-level configuration depicted in FIG. 16B, the distance D of insertion of the resonator structures 20 is shifted by about ⅓, such that the entire length of one resonator structure 20 extends from the dielectric substrate 16, ⅔ of the length of another resonator structure 20 extends from the dielectric substrate 16, and ⅓ of another resonator structure 20 extends from the dielectric substrate 16.

With reference back to FIGS. 1-16D, the various embodiments are illustrative of how the number, size, shape, location, positioning of the resonator structures 20, the depth of the holes 22 and a distance “D” that the resonator structures 20 extend into a respective one of the holes 22, and the presence of the conductive wire 34 can be used to optimize performance of the dielectric resonator antenna 10. In addition to the previously illustrated embodiments, it should be appreciated that the dielectric resonator antenna 10 may include more or less resonator structures 20, resonator structures 20 of varying shapes and materials, and other combinations of the features previously set forth without departing from the scope of the subject disclosure.

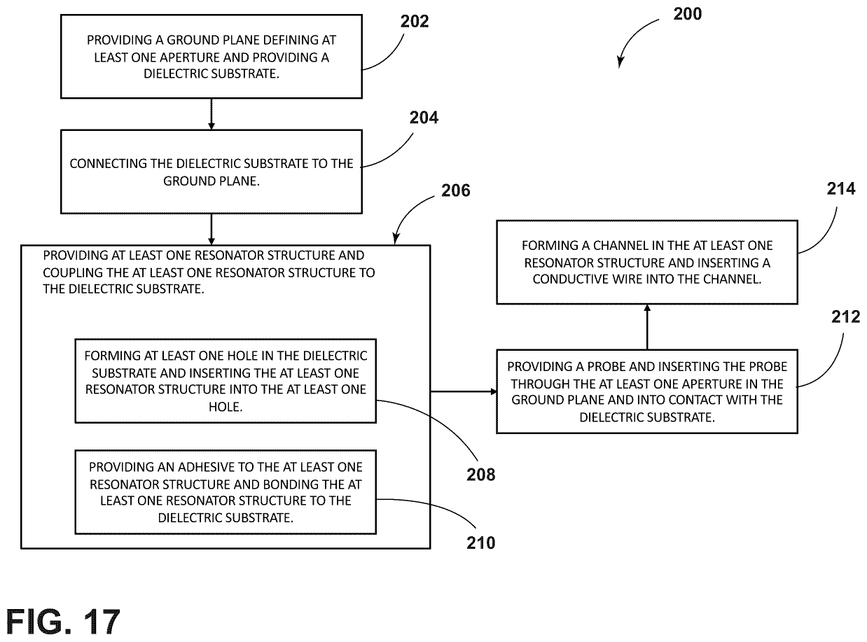

With reference now to FIG. 17, a method 200 of assembling a dielectric resonator antenna, such as the dielectric resonator antennas 10 depicted in FIGS. 1-16D, is provided. The method 200 may include, at step 202, providing a ground plane defining at least one aperture and providing a dielectric substrate. At step 204 the method 200 may include connecting the dielectric substrate to the ground plane. For example, the dielectric substrate may be located on top of the ground plane or in an aperture defined by the ground plane. At step 206 the method 200 may include providing at least one resonator structure and coupling the at least one resonator structure to the dielectric substrate. The at least one resonator structure may be formed of zirconia (e.g., a zirconia ferrule) and/or may be 3D printed. In some embodiments, step 206, may include, at step 208, forming at least one hole in the dielectric substrate and inserting the at least one resonator structure into the at least one hole. The at least one hole may be pre-drilled into the dielectric substrate. In some embodiments, the at least one hole may include a plurality of holes and the at least one resonator structure may include a plurality of resonator structures, each resonator structure may be inserted into different ones of the plurality of holes. The resonator structures and holes may be patterned such as those depicted in FIGS. 1-16D. In some embodiments, at least two of the resonator structures may be inserted into the same or different ones of the plurality of holes at different depths. Step 206 may include, at step 210, providing an adhesive to the at least one resonator structure and bonding the at least one resonator structure to the dielectric substrate. The method 200 may further include at step 212, providing a probe and inserting the probe through the at least one aperture in the ground plane and into contact with the dielectric substrate. At step 214 the method 200 may include forming a channel in the at least one resonator structure and inserting a conductive wire into the channel.

The method 200 may incorporate any and all specific details of the embodiments provided in FIGS. 1-16D, including the number, size, shape, location, and positioning of the resonator structures 20, the distance the resonator structures 20 are inserted in holes 22, and the presence of conductive wire 34.

The disclosure is further summarized in the following paragraphs and is further characterized by combinations of any and all of the various aspects described therein.

According to one embodiment, a dielectric resonator antenna includes a ground plane defining at least one aperture, a dielectric substrate, and a resonator assembly. The resonator assembly includes a plurality of resonator structures, each resonator structure is coupled to the dielectric substrate. A probe extends through the at least one aperture in the ground plane and is coupled to the dielectric substrate.

According to one aspect, a dielectric substrate defines a plurality of holes and each of a plurality of resonator structure is located in a different one of the holes.

According to another aspect, each hole of a plurality of holes is defined by a hole perimeter and each resonator structure of a plurality of resonator structures is defined by an outer resonator perimeter, the outer resonator perimeter being between about 98% and about 100% a size of the hole perimeter.

According to yet another aspect, at least two of a plurality of resonator structures extend into a respective one of holes at different distances.

According to still yet another aspect, a plurality of resonator structures are at least one of a cylindrical shape, a rectangular prism shape, and a spherical shape.

According to one aspect, a plurality of resonator structures are formed of zirconia.

According to another aspect, a plurality of resonator structures are glued to a ground plane.

According to yet another aspect, a dielectric substrate defines a first surface in contact with a ground plane and a second surface facing away from the ground plane.

According to still yet another aspect, a dielectric substrate is located in an at least one aperture and defines an outer perimeter in contact with a ground plane.

According to one aspect, at least one of a plurality of resonator structures includes a conductive wire extending at least partially therethrough.

According to another aspect, at least one of a plurality of resonator structures extends through at least one aperture in a ground plane.

According to yet another aspect, a plurality of resonator structures are located within a boarder and a probe is outside of the boarder.

According to another embodiment, a method of assembling a dielectric resonator antenna includes providing a ground plane defining at least one aperture, providing a dielectric substrate, and connecting the dielectric substrate to the ground plane. At least one resonator structure is provided and coupled to the dielectric substrate. A probe is provided and inserted through the at least one aperture in the ground plane and into contact with the dielectric substrate.

According to one aspect, a method includes forming at least one hole in a dielectric substrate and inserting at least one resonator structure in the at least one hole.

According to another aspect, at least one hole includes a plurality of holes and at least one resonator structure includes a plurality of resonator structures, each resonator structure is inserted into different ones of the plurality of holes.

According to yet another aspect, at least two of the resonator structures are inserted into different ones of a plurality of holes at different depths.

According to still yet another aspect, a method includes forming a channel in at least one resonator structure and inserting a conductive wire into the channel.

According to one aspect, a method includes providing an adhesive to at least one resonator structure and bonding the at least one resonator structure to the dielectric substrate.

According to yet another embodiment, a method of assembling a dielectric resonator antenna includes providing a ground plane defining at least one aperture, providing a dielectric substrate and forming a plurality of holes in the dielectric substrate, and connecting the dielectric substrate to the ground plane. A plurality of resonator structures are provided and inserted into different ones of the plurality of holes. A probe is provided and inserted through the at least one aperture in the ground plane and one of the plurality of holes.

According to one aspect, a method includes forming a channel in at least one of the plurality of resonator structures and inserting a conductive wire into the channel.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

What is claimed is:

1. A dielectric resonator antenna, comprising:
a ground plane defining at least one aperture;
a dielectric substrate;
a resonator assembly including a plurality of resonator structures, each resonator structure coupled to the dielectric substrate; and
a probe extending through the at least one aperture in the ground plane and coupled to the dielectric substrate.

2. The dielectric resonator antenna according to claim 1, wherein the dielectric substrate defines a plurality of holes and each resonator structure is located in a different one of the holes.

3. The dielectric resonator antenna according to claim 2, wherein each hole is defined by a hole perimeter and each resonator structure is defined by an outer resonator perimeter, the outer resonator perimeter being between about 98% and about 100% a size of the hole perimeter.

4. The dielectric resonator antenna according to claim 3, wherein at least two of the plurality of resonator structures extend into a respective one of the holes at different distances.

5. The dielectric resonator antenna according to claim 1, wherein the plurality of resonator structures are at least one of a cylindrical shape, a rectangular prism shape, and a spherical shape.

6. The dielectric resonator antenna according to claim 1, wherein the plurality of resonator structures are formed of zirconia.

7. The dielectric resonator antenna according to claim 1, wherein the plurality of resonator structures are glued to the ground plane.

8. The dielectric resonator antenna according to claim 1, wherein the dielectric substrate defines a first surface in contact with the ground plane and a second surface facing away from the ground plane.

9. The dielectric resonator antenna according to claim 1, wherein the dielectric substrate is located in the at least one aperture and defines an outer perimeter in contact with the ground plane.

10. The dielectric resonator antenna according to claim 1, wherein at least one of the plurality of resonator structures includes a conductive wire extending at least partially therethrough.

11. The dielectric resonator antenna according to claim 1, wherein at least one of the plurality of resonator structures extends through the at least one aperture in the ground plane.

12. The dielectric resonator antenna according to claim 1, wherein the plurality of resonator structures are located within a boarder and the probe is outside of the boarder.

13. A method of assembling a dielectric resonator antenna, the method comprising:
providing a ground plane defining at least one aperture;
providing a dielectric substrate;
connecting the dielectric substrate to the ground plane;
providing at least one resonator structure and coupling the at least one resonator structure to the dielectric substrate; and
providing a probe and inserting the probe through the at least one aperture in the ground plane and into contact with the dielectric substrate.

14. The method according to claim 13, further including forming at least one hole in the dielectric substrate and inserting the at least one resonator structure in the at least one hole.

15. The method according to claim 14, wherein the at least one hole includes a plurality of holes and the at least one resonator structure includes a plurality of resonator structures, each resonator structure inserted into different ones of the plurality of holes.

16. The method according to claim 15, wherein at least two of the resonator structures inserted into different ones of the plurality of holes at different depths.

17. The method according to claim 13, further including forming a channel in the at least one resonator structure and inserting a conductive wire into the channel.

18. The method according to claim 13, further including providing an adhesive to the at least one resonator structure and bonding the at least one resonator structure to the dielectric substrate.

19. A method of assembling a dielectric resonator antenna, the method comprising:
providing a ground plane defining at least one aperture;
providing a dielectric substrate and forming a plurality of holes in the dielectric substrate;
connecting the dielectric substrate to the ground plane;
providing a plurality of resonator structures and inserting each resonator structure into different ones of the plurality of holes; and
providing a probe and inserting the probe through the at least one aperture in the ground plane and one of the plurality of holes.

20. The method according to claim 19, further including forming a channel in the at least one of the plurality of resonator structures and inserting a conductive wire into the channel.
